(19) United States
(12) Patent Application Publication
(10) Pub. No.: US 2010/0151895 A1
(43) Pub. Date: Jun. 17, 2010

(54) METHOD FOR MANAGING COMPETING CALL REQUESTS

(75) Inventors: DANIEL J. MCDONALD, CARY, IL (US); JOHN KEDZIERSKI, CHICAGO, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/335,770

(22) Filed: Dec. 16, 2008

(51) Int. Cl. H04B 7/00

(52) U.S. Cl. 455/518

(57) ABSTRACT

Granting multiple communication paths for a single talkgroup call for interrupting a transmission or allowing a dispatch operator to listen to multiple units transmitting simultaneously on the same talkgroup call is disclosed. Upon a first unit being keyed, the controller assigns a first communication channel to a call, whereby the first unit begins transmitting using an inbound link of the first communication channel. If a second unit participating in the call is keyed during the call, the controller assigns a second communication channel to the call, and the second unit begins transmitting on the inbound link of the second communication channel. The call information for both transmissions from the first and second units may be simultaneously routed to dispatch consoles monitoring the call. If the controller determines that the first unit should be interrupted, the transmission from the second unit is broadcast by the base sites involved in the call.

### TECHNICAL FIELD OF THE DISCLOSURE

This disclosure relates generally to communication systems, and more particularly, to a method for managing competing call requests in a single talkgroup call.

### BACKGROUND OF THE DISCLOSURE

Communication systems typically comprise a plurality of dispatch consoles and communication units, such as mobile or portable radio units, that are geographically distributed among various base sites and console sites. The communication units wirelessly communicate with the base sites and each other, and are often logically divided into various talkgroups. Communication systems may be organized as trunked systems, where a plurality of radio frequency (RF) communication resources are allocated amongst multiple users or groups by assigning the base sites and RF channels within a coverage area on a call-by-call basis, or as conventional (non-trunked) systems where RF communication resources are dedicated to one or more users or groups. In trunked systems, or in mixed trunked and conventional systems, there is usually provided a controller/server (sometimes called a “zone controller”) for allocating RF communication resources among a group of sites. The zone controller may reside within a single device, or multiple devices, and may be located at a fixed equipment site or may be distributed among the base sites.

Calls among the communication units are typically of the dispatch type, or better known as push-to-talk (PTT). Each time a communication unit is keyed to begin a call, the call is assigned to an available wireless channel. The originating communication unit begins transmitting on the assigned channel and continues to transmit on the assigned channel until the communication unit has been dekeyed by the user. Other communication units in an associated talkgroup also switch to the assigned channel and begin listening to the call.

In current communication systems, there is often a need to support simultaneous transmissions during an active talkgroup call, whether for the purpose of interrupting one communication unit with another communication unit or to allow a plurality of communication units in one talkgroup to send inbound transmissions simultaneously such that the transmissions can be heard by other users in the talkgroup. When the communication units are at different sites, the network may be reconfigured to allow audio from the interrupting communication unit to be the source of the call. However, if the interrupting communication unit is at the same base site as the communication unit being interrupted, current communication systems allow the interrupting communication unit to transmit simultaneously on the same channel as the already transmitting communication unit. This results in one of three outcomes based on the RF characteristics of the system: 1) the transmission from the interrupted communication unit is heard as opposed to the interrupting communication unit, 2) the transmission from the interrupting communication unit is heard as opposed to the interrupted communication unit or 3) the transmissions from the two communication units interfere with each other, and no audio is heard. Thus, in current communication systems, there is not a reliable and/or effective method to support simultaneous transmissions during an active talkgroup call such that the transmissions can be heard by other users in the talkgroup.

### BRIEF DESCRIPTION OF THE FIGURES

Various embodiment of the disclosure are now described, by way of example only, with reference to the accompanying figures.

FIG. 1 shows one embodiment of a communication system in accordance with the present disclosure.

FIGS. 2a-c shows one embodiment of a process for managing competing call requests in accordance with the present disclosure.

FIGS. 3a-3b illustrate one exemplary embodiment utilizing the process of FIG. 2 in accordance with the present disclosure.

FIG. 4 shows a second embodiment of a process for managing competing call requests in accordance with the present disclosure.

FIGS. 5a-5b illustrate one exemplary embodiment utilizing the process of FIG. 4 in accordance with the present disclosure.

FIG. 6 shows a third embodiment of a process managing competing call requests in accordance with the present disclosure.

FIGS. 7a-7b illustrate one exemplary embodiment utilizing the process of FIG. 6 in accordance with the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions with respect to their corresponding respective areas of inquiry and study except where specific meaning have otherwise been set forth herein.

### DETAILED DESCRIPTION OF THE DISCLOSURE

The present disclosure provides a method for granting multiple communication paths for a single talkgroup call for the purposes of interrupting a transmission or allowing a dispatch console operator to listen to multiple communication units transmitting simultaneously on the same talkgroup call in a communication system. The system comprises a controller coupled to one or more base sites, each of which is in wireless communication with a plurality of communication units. Upon a first communication unit being keyed, the controller is configured to assign a first communication channel to a talkgroup call, whereby the first communication unit begins transmitting using an inbound link of the first communication channel. If a second communication unit participating in the call is keyed during the call, the controller assigns a second communication channel to the call, and the second communication unit begins transmitting on the inbound link of the second communication channel. The call information for both transmissions from the first and second communication units may then be simultaneously routed to dispatch consoles monitoring the talkgroup call. If the controller determines that the first transmission from the first communication unit should be interrupted, the transmission from the second communication unit is broadcast by the base sites to the receiving communication units involved in the talkgroup call.

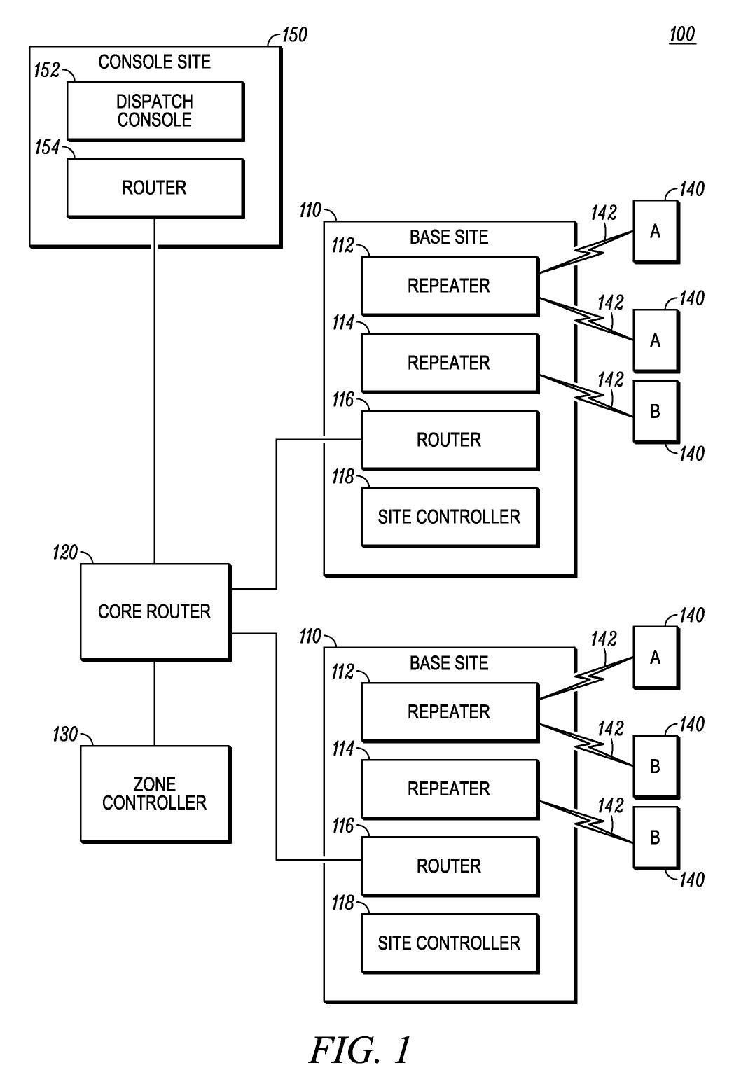

Let us now discuss the present disclosure in greater detail by referring to the figures below. FIG. 1 shows one embodiment of a single-zone in a communication system 100. The system 100 comprises a plurality of base sites 110 that are in communication with a core router 120. The core router 120 is also coupled to a zone controller 130. The zone controller 130 is responsible for assigning communication channels at the base sites 110.

As illustrated in FIG. 1, each base site 110 is comprised of a plurality of repeaters 112, 114 that are coupled, for example via Ethernet, to an associated router 116, which is in turn coupled to the core router 120. Of course, while each base site 110 is illustrated having two repeaters 112, 114, it is understood that any number of repeaters may be provided at each base site 110. Each router 116 is also coupled to a site controller 118. The site controller 118 is configured to handle communication channel assignments for its respective base site 110 in the event the base site 110 is unable to communicate with the zone controller 130. For purposes of the following description, it is assumed that the base sites are able to communicate with the zone controller unless otherwise noted.

The repeaters 112, 114 at each base site 110 communicate using wireless communication resources 142 with communication units 140 within a specific coverage area. The wireless communication resources 142 may comprise any type of communication resource, such as, for example, RF technologies, including, but not limited to Frequency Division Multiple Access (FDMA), Time Division Multiple Access (TDMA), Code Division Multiple Access (CDMA), Orthogonal Frequency Division Multiple Access (OFDMA), and the like. Other wireless technologies, such as those now known or later to be developed and including, but not limited to, infrared, Bluetooth, electric field, electromagnetic, or electrostatic transmissions, may also offer suitable substitutes.

The communication units 140 may be mobile or portable wireless radio units, cellular radio/telephones, video terminals, portable computers with wireless modems, or any other wireless devices. The communication units 140 may also be arranged into talkgroups having corresponding talkgroup identifications as known in the art. In FIG. 1, two separate talkgroups are illustrated, identified by labels “A” and “B.” Of course, any number of talkgroups having corresponding talkgroup identifications may be established within the system 100. Although not shown in FIG. 1, each communication unit 140 may also comprise application software for receiving, decoding, and taking actions based on transmitted data messages. The application software may be integral to the communication unit or operated by a secondary device, such as a portable computer, that is coupled to the communication unit.

The core router 120 may also be further coupled to a console site 150. The console site 150 comprises at least one dispatch console 152 that is coupled, for example via Ethernet, to a router 154, which is in turn coupled to the core router 120. Dispatch console 152 can affiliate with either or both talkgroups “A” and “B” and, accordingly, may be considered members of both talkgroups “A” and “B.” Although not shown in FIG. 1, it will be appreciated that a single site may include both repeaters and dispatch consoles. In one embodiment, the base sites 110, the core router 120, the zone controller 130 and the console site 150 may be coupled using T1 lines, E1 lines, fiber optic lines, wireless links, Ethernet links, or any other suitable means for transporting data between the various components.

Practitioners skilled in the art will appreciate that the system 100 may also comprise various other elements not shown in FIG. 1. For example, although only two base sites 110 and one console site 150 are illustrate in FIG. 1, the system may comprise any number of base sites 110 or console sites 150. The system 100 may comprise remote sites configured to provide simulcast transmissions. The system 100 may also comprise multiple interconnected zones, each containing a zone controller 130, base sites 110, and console sites 150. The system 100 may also be linked to a public switched telephone network (PSTN), a paging network, or a facsimile machine. The communication system 100 may also be connected to a number of additional content sources, such as the Internet or various Intranets.

When a first communication unit 140 is keyed to initiate a call, the zone controller 130 assigns an available wireless communication channel for each base site 110 at which a communication unit 140 that is to receive the talkgroup call is present to the call. The term “call”, as used herein, may include any type of multimedia transmission (such as voice, data, or video), as well as transmissions comprising system control information. In one embodiment, the communication channel may be comprised of an outbound link for transmissions from the base site 110 to the communication units 140 and an inbound link for transmissions from the communication units 140 to the base site 110. For example, in a TDMA system, the outbound link may be comprised of one or more time slots (also referred to as outbound time slots) and the inbound link may be comprised of one or more other time slots (also referred to as inbound time slots). The time slots used for the inbound and outbound links may also be on the same frequency channel or on different frequency channels.

At each base site 110, the channel assignment is then advertised to the communication units 140 via one or more communication channels. In one exemplary embodiment, the channel assignment may be advertised via a dedicated control channel that is used by one or more base sites 110 for transmitting various call initiation signals and identification codes. In other embodiments, however, the communication system 100 may not include a dedicated control channel, in which case communication traffic may be delivered on any communication channel in the communication system 100.

Upon receiving the channel assignment, the first communication unit 140 which requested the call begins transmitting to the base site 110 using the inbound link of the assigned communication channel. Communication units 140 authorized to receive the transmission (i.e. communication units in the same talkgroup) also obtain the channel assignment and begin listening to the call on the outbound link of the assigned communication channel. For purposes of this disclosure, a communication unit 140 that is transmitting on the inbound link is referred to as a transmitting communication unit while a communication unit 140 that is listening on an outbound link is referred to as a receiving communication unit.

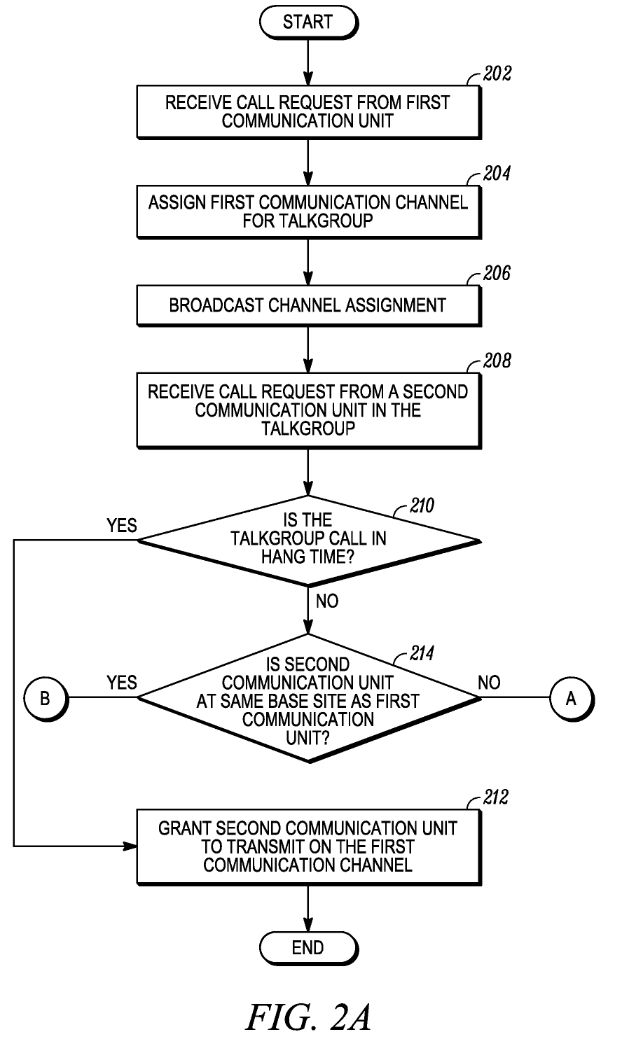

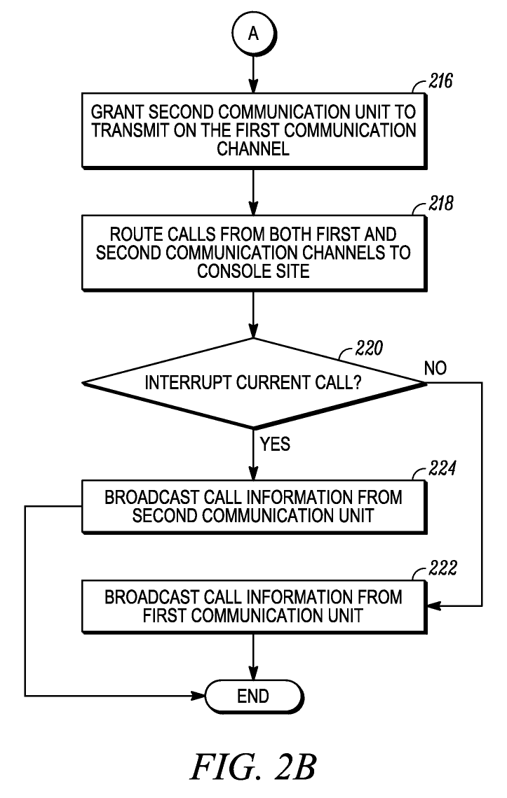

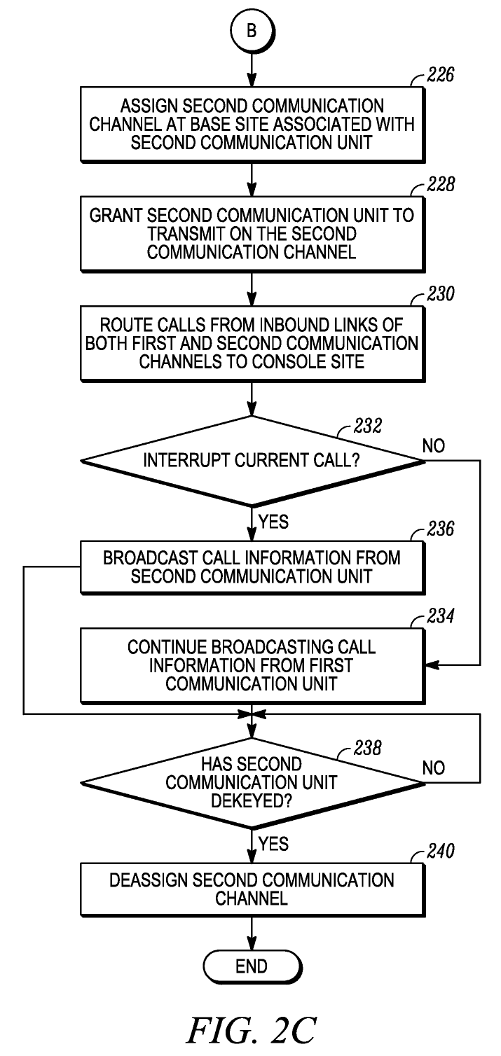

According to one exemplary embodiment of the present disclosure, FIGS. 2a-c illustrate one embodiment of a method for interrupting a transmission from a first communication unit. In step 202, a first call request is received from a first communication unit. The first call request is routed to the zone controller 130 and, in step 204, a first communication channel is assigned at each base site 110 at which a communication unit that is to receive the talkgroup call is present as well as at the base site 110 in communication with the first communication unit. The channel assignment at each base site 110 is advertised to the receiving communication units 140 in the talkgroup and the first communication unit which initiated the talkgroup call begins transmitting on the inbound link of the assigned first communication channel in step 206. Although not illustrated in FIG. 2, it is understood that each of the base sites 110 also begins broadcasting the transmission of the talkgroup call from the first communication unit on the outbound link of the first communication channel assigned at each respective base site 110, and the call information associated with the transmission from the first communication unit is routed to the dispatch consoles 152 monitoring the talkgroup call.

In step 208, a second call request is received from a second communication unit on the established talkgroup call. In step 210, after receiving the second call request, the zone controller 130 determines whether the talkgroup call is in hangtime, that is, whether any communication unit that is participating in the current talkgroup call is currently transmitting. If the talkgroup call is in hangtime, the zone controller 130 transmits a grant message instructing the second communication unit to begin transmitting on the inbound link of the first communication channel in step 212. The received transmission from the second communication unit is then broadcast to the receiving communication units at each base site 110 on the outbound link of the first communication channel, and the call information associated with the transmission from the second communication unit is routed to the dispatch consoles 152 monitoring the talkgroup call.

If the talkgroup call is not in hangtime, it is determined whether the second communication unit is at the same base site as the first communication unit that is currently transmitting in step 214. If the first and second communication units are not at the same base site, the method proceeds to process “A”, which is illustrated in FIG. 2b. If the first and second communication units are at the same base site, the method proceeds to process “B”, which is illustrated in FIG. 2c.

Turning first to FIG. 2b, if the first and second communication units are at different base sites, the zone controller 130 transmits a grant message instructing the second communication unit to begin transmitting on the inbound link of the first communication channel assigned at the base site that is in communication with the second communication unit in step 216. The call information associated with the transmissions from both the first and second communication units may also be routed to the dispatch consoles 152 monitoring the talkgroup call in step 218. As a result, one or more dispatch console operators at the dispatch consoles 152 can receive the call information associated with the transmissions from not only the second communication unit, but also the first communication unit. As noted above, the call information being received by a dispatch console operator may be voice, data, video, or the like. Thus, the dispatch consoles 152 may comprise multiple audio speakers, video screens, computer terminals, or the like.

In step 220, the zone controller 130 determines whether the transmission from the first communication unit is to be interrupted. For example, the transmission from the first communication unit may be interrupted if the second communication unit is of a higher priority than the first communication unit, or if the transmission from the second communication unit is identified as an emergency transmission. If the transmission from the first communication unit is not to be interrupted, the base sites 110 involved in the call may continue broadcasting the transmission from the first communication unit in step 222. If the transmission from the first communication unit is to be interrupted, the base sites 110 involved in the call stop broadcasting the transmission from the first communication unit, and instead begin broadcasting the transmission from the second communication unit in step 224. This is accomplished by routing the transmission from the second communication unit to the outbound link of the first communication channel assigned at each base site 110.

Turning to FIG. 2c, if the first and second communication units are at the same base site 110, the zone controller 130 assigns a second communication channel to the call at that base site in step 226, and a grant message is transmitted instructing the second communication unit to begin transmitting on the inbound link of the second communication channel in step 228. In step 230, the call information associated with both transmissions from the first communication unit (on the first communication channel) and the second communication unit (on the second communication channel) may also be routed to the dispatch consoles 152 monitoring the talkgroup call so that each may be received by one or more dispatch console operators at the console site 150.

In step 232, the zone controller 130 determines whether the transmission from the first communication unit is to be interrupted. If the transmission from the first communication unit is not to be interrupted, the base sites 110 involved in the call may continue broadcasting the transmission from the first communication unit in step 234. If the transmission from the first communication unit is to be interrupted, the base sites 110 involved in the call stop transmitting the transmission from the first communication unit (i.e. the interrupted communication unit), and instead begin broadcasting, on the outbound link of the first communication channel at each base site, the transmission from the second communication unit via the second communication channel in step 236. As a result, the transmission from the second communication unit is provided to the receiving communication units without significant delay or potential interference between the first and second communication units. Although not shown, the transmission from the second communication unit may also be broadcast on the outbound link of the second communication channel so that any communication units monitoring the second communication channel will also receive the transmission from the second communication unit.

In step 238, it is determined whether the second communication unit has dekeyed or stopped transmitting. After the second communication unit has dekeyed, the zone controller 130 deassigns the second communication channel being utilized by the second communication unit in step 240, and the second communication unit is instructed to return to the first communication channel. If the transmission from the first communication unit was interrupted, then, in step 240, the base sites 110 involved in the call may resume broadcasting the transmission from first communication unit. For ease of explanation, the present disclosure describes a second communication unit attempting to interrupt a first communication unit, however, any number of communication units in the talkgroup may attempt to interrupt the at least one communication unit transmitting on the call. Thus, it is important to note that the zone controller may receive a call request from a plurality of communication units in the talkgroup while at least the first and second communication units are transmitting. In such a case, a call request is received from each communication unit in the talkgroup that wants to transmit while the at least the first and second communication units are transmitting. The zone controller assigns an additional communication channel for each communication unit that transmitted a call request, and receives an additional transmission for the call from each additional communication unit on their respectively assigned communication channels. The call information associated with each additional transmission for the call from each additional communication unit is also routed to the at least one dispatch console monitoring the call.

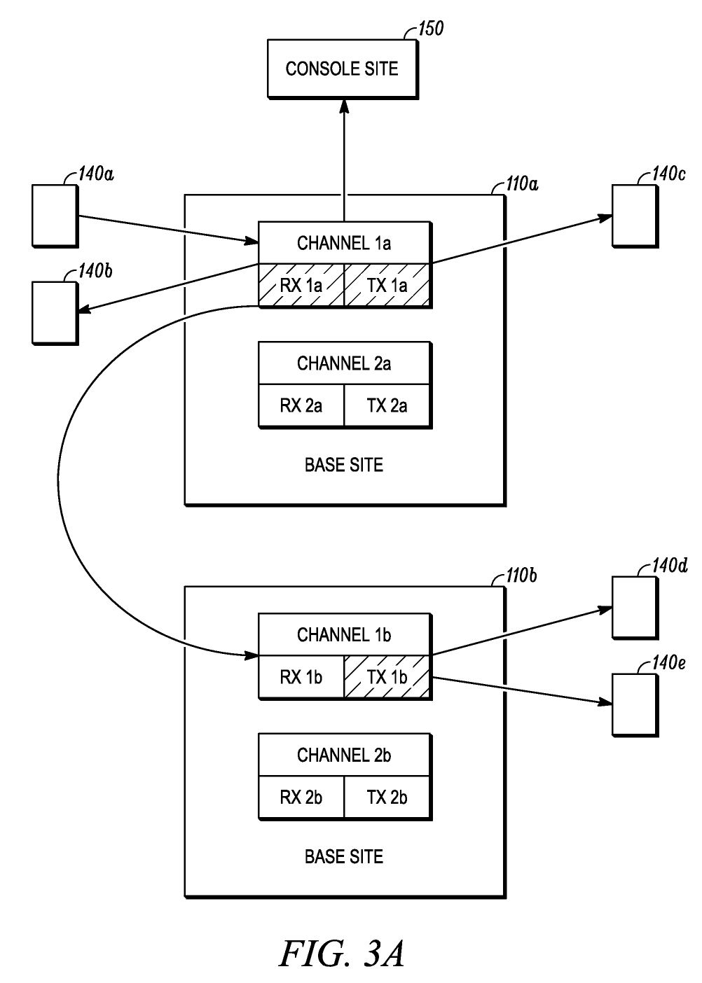

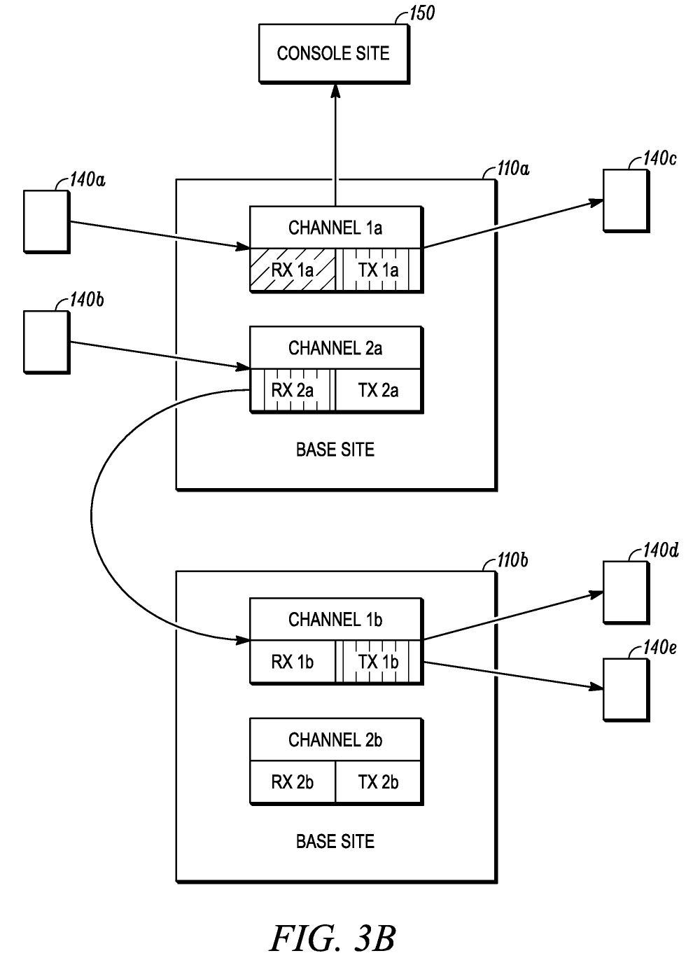

To further illustrate the present disclosure, FIGS. 3a and 3b show one exemplary embodiment of a communication system utilizing the present disclosure, and in particular, the process described in FIG. 2c. In FIGS. 3a and 3b, five communication units 140a-e are illustrated in association with two base sites 110a and 110b, although it should be understood that any number of communication units and base sites may be utilized.

FIG. 3a illustrates a scenario where a call has been initiated for a given talkgroup, and a first communication channel has already been assigned to the call at both base sites 110a and 110b. In this example, the assigned first communication channel at base site 110a is identified as “Channel 1a” and the assigned first communication channel at base site 110b is identified as “Channel 1b”. In FIG. 3a, the first communication unit 140a is shown as transmitting on the inbound link of the Channel 1a (RX1a) at base site 110a. The transmission from the first communication unit 140a is also shown as being broadcast to receiving communication units 140b-e on the outbound links of Channel 1a (TX1a) and Channel 1b (TX1b) at base sites 110a and 110b, respectively.

In FIG. 3b, let us now assume that a second communication unit 140b is keyed to initiate a transmission in the call while the first communication unit 140a is still transmitting in the call. For purposes of this example, it is also assumed that the second communication unit 140b is at the same base site as the first communication unit 140a, and that the second communication unit 140b has a sufficient priority level, or otherwise is permitted to interrupt the first communication unit 140a.

As shown in FIG. 3b, a second communication channel (e.g., Channel 2a) is assigned to the talkgroup call at base site 110a and the second communication unit 140b begins transmitting on the inbound link of Channel 2a (RX2a). In addition, base sites 110a and 110b stop transmitting the transmission received from the first communication unit 140a (on RX1a), and instead begin broadcasting (on TX1a and TX1b) the transmission received from the second communication unit 140b (on RX2a). Although not shown, the transmission from the second communication unit 140b may also be broadcast on the outbound link of Channel 2a (TX2a) so that any communication units monitoring Channel 2a will also receive the transmission. The call information associated with both transmissions being received from the first and second communication units 140a and 140b may also be simultaneously routed to the dispatch consoles 152 monitoring the talkgroup call.

Although not explicitly shown in the figures, once the second communication unit 140b is dekeyed, Channel 2a may be deassigned from the talkgroup call. In this case, the second communication unit 140b may be instructed to tune back to Channel 1a, and the system would resume operation as described in FIG. 3a. It should also be understood that if the second communication unit 140b was not permitted to interrupt the first communication unit 140a, base sites 110a and 110b may continue broadcasting the transmission from the first communication unit 140a, but the call information associated with both transmissions received from the first and second communication unit may still be routed to the dispatch consoles 152 monitoring the talkgroup call.

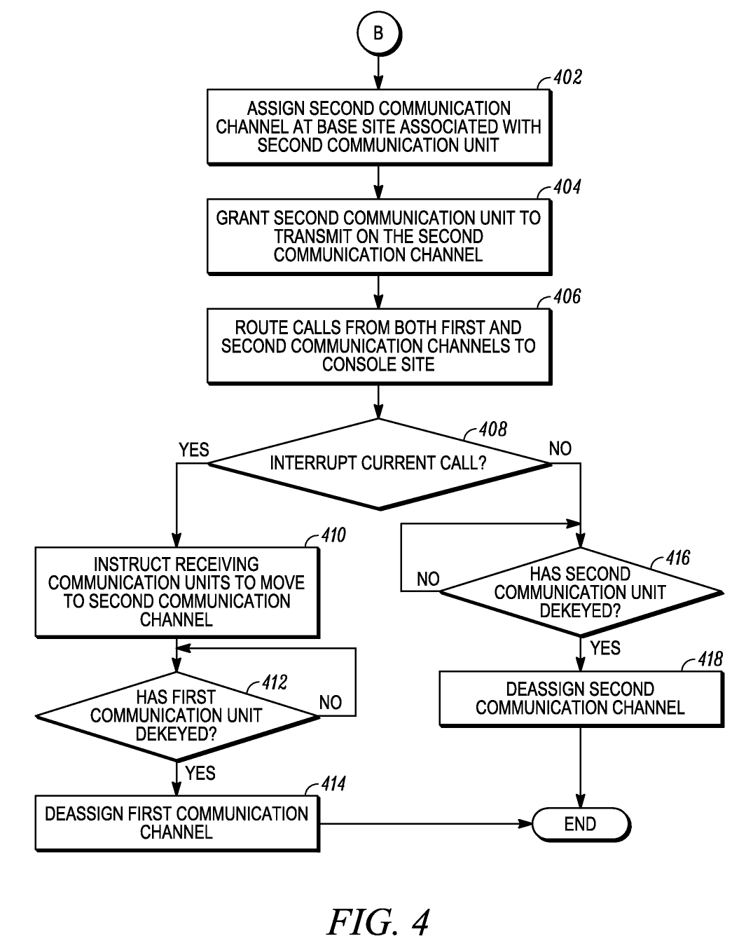

FIG. 4 illustrates another embodiment of a process “B” for managing competing call requests for the same talkgroup call from two communication units 140 at a single base site 110. In this embodiment, if the first and second communication units are at the same base site 110, the zone controller 130 assigns a second communication channel at that base site in step 402, and a grant message is sent instructing the second communication unit to begin transmitting on the inbound link of the second communication channel in step 404. The call information associated with the transmission received from the first communication unit (on the first communication channel) and the transmission received from the second communication unit (on the second communication channel) may be routed to the dispatch consoles 152 monitoring the talkgroup call in step 406.

In step 408, the zone controller 130 determines whether the transmission received from the first communication unit is to be interrupted by the transmission received from the second communication unit. If the transmission from the first communication unit is to be interrupted, the communication units receiving the transmission from the first communication unit on the first communication channel are instructed to tune to the second communication channel to receive the transmission from the second communication unit in step 424. This allows the receiving communication units to begin receiving the transmission from the second communication unit that is being broadcast on the second communication channel.

To permit the call information associated with the transmission from the first communication unit and the call information associated with the transmission from the second communication unit to be routed to the dispatch consoles 152 monitoring the talkgroup call, the first communication channel may continue to be assigned to the talkgroup call until the first communication unit dekeys. After the first communication unit is determined to have dekeyed in step 412, the first communication channel may be deassigned in step 414. The first communication unit may then join the transmission proceeding on the second communication channel.

If, in step 408, it is determined that the transmission from the first communication unit is not to be interrupted, then receiving communication units remain on the first communication channel to receive the transmission from the first communication unit. In this instance, the assigned second communication channel may continue to be assigned for the talkgroup call until the second communication unit dekeys so that the call information associated with both transmissions can be routed to the dispatch consoles 152 monitoring the talkgroup call. After the second communication unit is determined to have dekeyed in step 416, the second communication channel may be deassigned in step 418. The second communication unit may then join the transmission proceeding on the first communication channel.

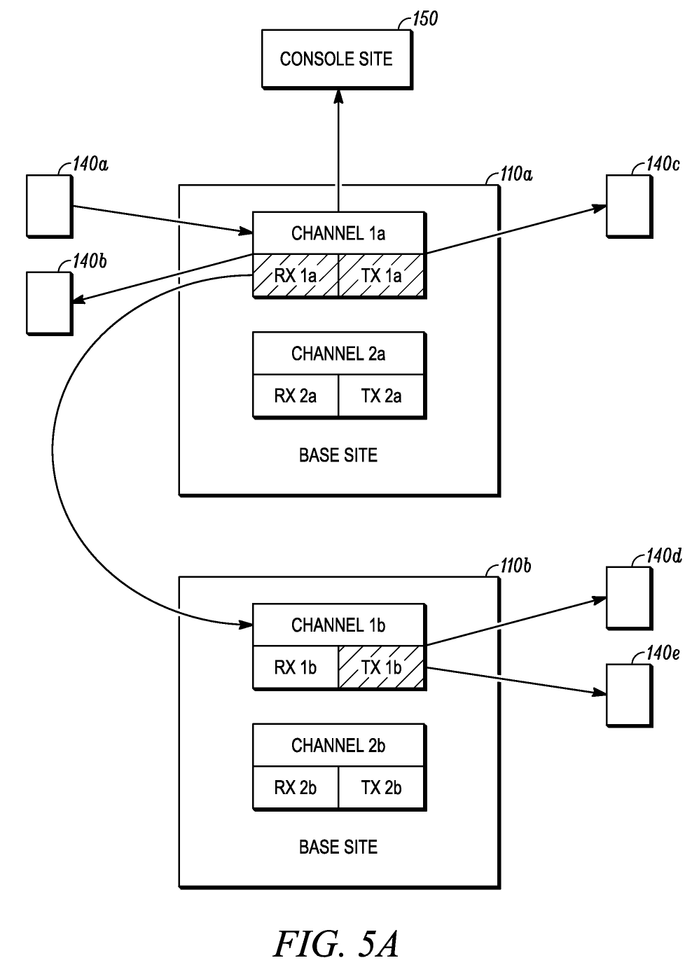

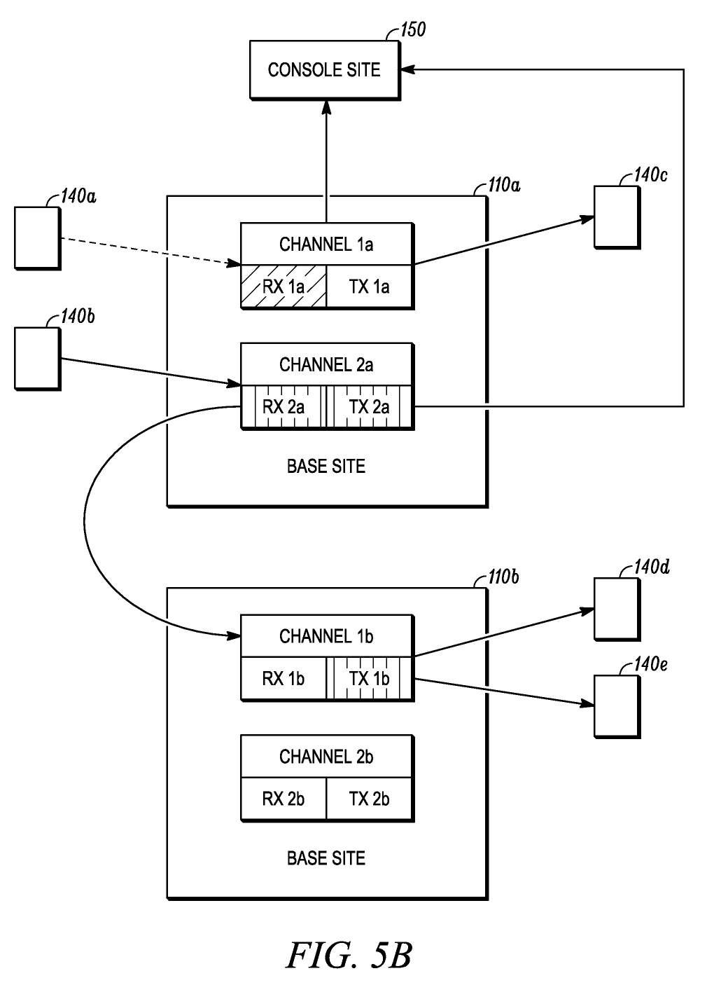

FIGS. 5a-b illustrate one example of a communication system utilizing the process described in FIG. 4. FIG. 5a illustrates the same scenario as previously described in FIG. 3a. That is, in FIG. 5a, a talkgroup call has already been established and a first communication channel has been assigned to the talkgroup call at base sites 110a and 110b. In this example, a first communication unit 140a is shown transmitting on the inbound link of the Channel 1a (RX1a) at base site 110a. The transmission from the first communication unit 140a is also being broadcast to the receiving communication units 140b-e on the outbound links of Channel 1a (TX1a) and Channel 1b (TX1b) at base sites 110a and 110b, respectively.

In FIG. 5b, let us now assume that the second communication unit 140b is keyed to initiate a call request for the talkgroup call while the first communication unit 140a is still transmitting for the talkgroup call. As in FIG. 3b, this example assumes that the second communication unit 140b is at the same base site as the first communication unit 140a, and that the second communication unit 140b has a sufficient priority level, or otherwise is permitted to interrupt the first communication unit 140a.

As shown in FIG. 5b, a second communication channel (e.g., Channel 2a) is assigned to the talkgroup call at base site 110a. In this embodiment, the second communication unit 140b is instructed to transmit on the inbound link of Channel 2a (RX2a), receiving communication unit 140c at base site 110a is instructed to tune to Channel 2a, and base site 110a begins broadcasting, on the outbound link of Channel 2a (TX2a), the transmission received from the second communication unit 140b. Base site 110b also broadcasts the transmission from the second communication unit 140b on the outbound link of Channel 1b (TX1b). The call information associated with the transmission from the first communication unit and the call information associated with the transmission from the second communication unit may also be simultaneously routed to the dispatch consoles 152 monitoring the talkgroup call.

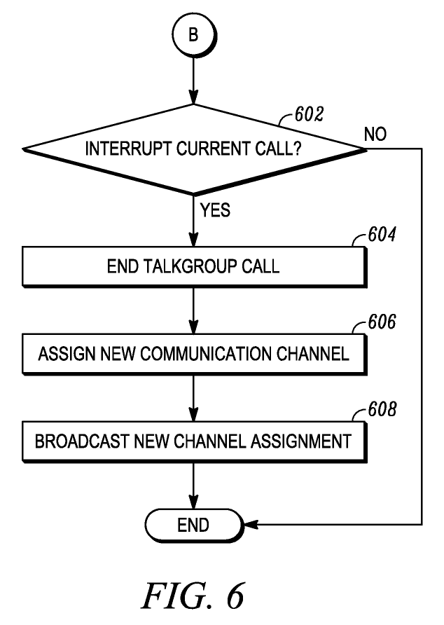

FIG. 6 illustrates yet another embodiment of a process “B” for managing competing call requests for a talkgroup call in a communication system. As will be understood from the embodiment disclosed in FIG. 6, while this embodiment permits a second communication unit to interrupt a first communication unit currently transmitting in a talkgroup call, it does not support simultaneously routing call information associated with multiple transmissions to the dispatch consoles 152 monitoring the talkgroup call.

As shown in FIG. 6, if the first and second communication units 140 are at the same base site 110, the zone controller 130 determines whether the transmission from the first communication unit should be interrupted by a transmission from the second communication unit in step 602. If the transmission from the first communication unit is to be interrupted, the zone controller 130 ends the transmission from the first communication unit (i.e. essentially ends the talkgroup call) at all the base sites associated with the call in step 604, assigns a new communication channel for the talkgroup call for each of the relevant base sites in step 606, and broadcasts the new channel assignment in step 608. The newly assigned communication channel may be the same communication channel being previously used for transmission from the first communication unit or a different communication channel. Upon receiving the new channel assignment, the second communication unit begins transmitting on the inbound link of the new communication channel, and the receiving communication units in the talkgroup begin receiving the transmission from the second communication unit on the outbound link of the new communication channel. If, in step 602, it is determined that the transmission from the first communication unit is not to be interrupted, then no action is taken and the transmission from the first communication unit continues to be broadcasts on the originally assigned first communication channel.

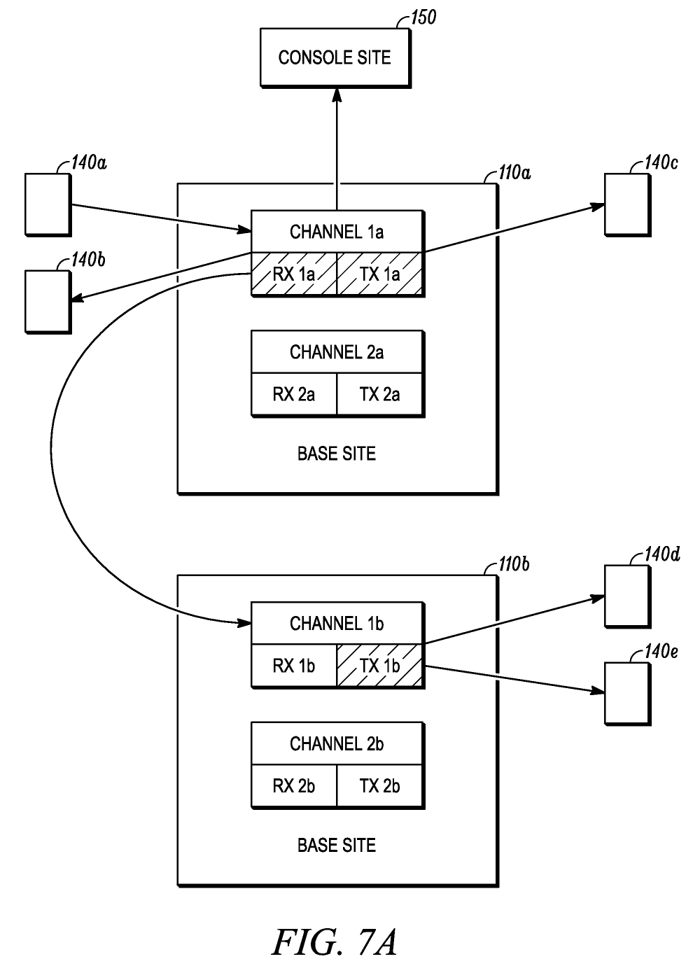

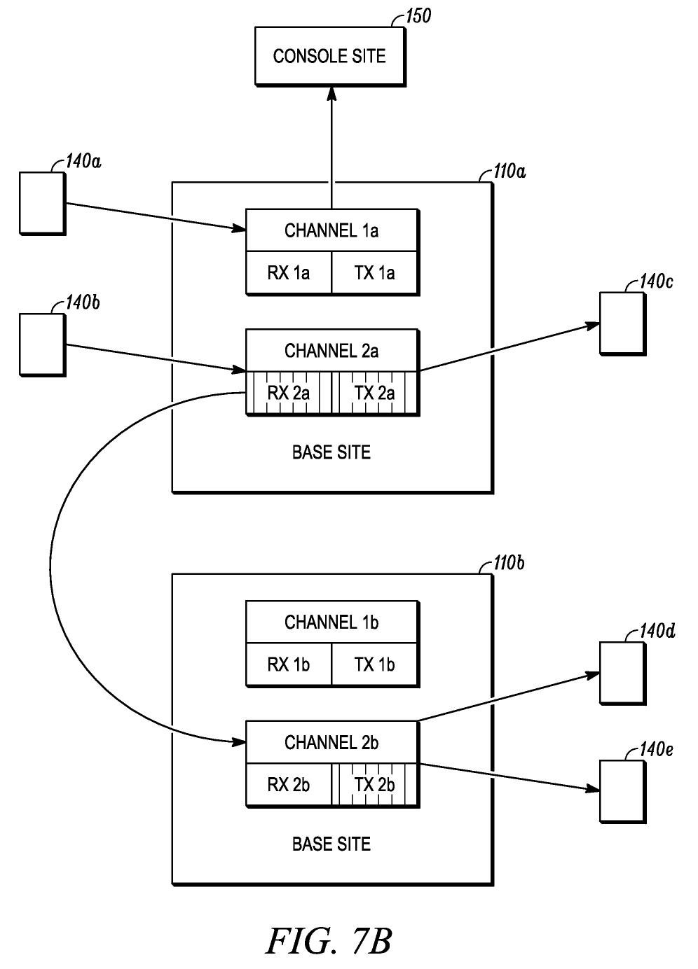

FIGS. 7a-b illustrates one example of a communication system utilizing the process described in FIG. 6. FIG. 7a illustrates the same scenario as previously described in FIGS. 3a and 5a. That is, in FIG. 7a, a call has already been established and a first communication channel has been assigned to the call at base sites 110a and 110b. In this example, the first communication unit 140a is shown transmitting on the inbound link of the Channel 1 (RX1a) at base site 110a. The transmission from the first communication unit 140a is also being broadcast to the receiving communication units 140b-e on the outbound links of Channel 1a (TX1a) and Channel 1b (TX1b) at base sites 110a and 110b, respectively.

In FIG. 7b, let us now assume that the second communication unit 140b is keyed to initiate a transmission for the talkgroup call while the first communication unit 140a is still transmitting for the talkgroup call. As in FIGS. 3b and 5b, this example assumes that the second communication unit 140b is at the same base site as the first communication unit 140a, and that the second communication unit 140b has a sufficient priority level, or otherwise is permitted to interrupt the first communication unit 140a.

As shown in FIG. 7b, a new communication channel is assigned for the call at both base sites 110a and 110b. In this example, the new communication channels for base sites 110a and 110b are Channels 2a and 2b, respectively. However, it is understood that the new communication channel may be any channel, including Channels 1a or 1b.

Once the second communication unit 140b receives the new channel assignment, the second communication unit 140b begins transmitting on the inbound link of Channel 2a (RX2a). The transmission from the second communication unit 140b is then broadcast by base sites 110a and 110b on the outbound links of Channels 2a (TX2a) and 2b (TX2b), respectively.

In FIG. 7b, it is also assumed that the first communication unit 140a is capable of operating only in half-duplex mode. Accordingly, in this illustrated example, the first communication unit 140a is not capable of receiving a message indicating the new channel assignment until the first communication unit 140a has dekeyed and stopped transmitting. However, it should be understood that once the first communication unit 140a has dekeyed, it may receive the new communication channel assignment and switch to the new communication channel to begin receiving the transmission from the second communication unit 140b. Of course, if the first communication unit 140a is capable of operating in full-duplex mode, or otherwise receiving information while transmitting, the first communication unit 140a may be configured to receive the new channel assignment while transmitting and tune to the new communication channel sooner.

The above description describes a transmission from one communication unit interrupting a transmission from another communication unit and broadcasting the transmission from the interrupting communication unit at the base sites. Alternatively, the present disclosure may merge the received transmissions for the call, or a subset of the received transmissions for the call, into one merged transmission and broadcast the merged transmission such that the merged transmission is heard by the receiving communication units.

Further advantages and modifications of the above described system and method will readily occur to those skilled in the art. For instance, the steps of the process described above may be performed in any order. As an example, if routing call information associated with the transmissions from the communication units to a dispatch console is not critical in a given communication system, it should be understood that in the processes described in FIGS. 2a-c and 4, the communication system may be configured to assign a second communication channel only when the second communication unit is determined to have permission to interrupt the first communication unit. It should also be understood that the disclosure described herein may be utilized to assign additional communication channels if multiple communication units are keyed at the same time, and to route call information associated with the transmissions from all such communication units to the dispatch consoles monitoring the talkgroup call.

The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A method for managing competing call requests from a plurality of communication units participating in a call in a communication system, the method comprising:
receiving a first call request for the call from a first communication unit;
assigning a first communication channel to the call;
receiving a transmission for the call from the first communication unit on an inbound link of the first communication channel;
receiving a second call request for the call from a second communication unit;
determining that the transmission for the call from the first communication unit should be interrupted by a transmission for the call from the second communication unit;
assigning a second communication channel to the call;
receiving the transmission for the call from the second communication unit on an inbound link of the second communication channel; and
broadcasting the transmission for the call from the second communication unit.

2. The method of claim 1 wherein the first communication unit and the second communication unit are operating at a same base site.

3. The method of claim 2 wherein broadcasting the transmission for the call from the second communication unit comprises broadcasting the transmission for the call from the second communication unit on the outbound link of the first communication channel.

4. The method of claim 3 further comprising:
determining that the second communication unit has stopped transmitting;
deassigning the second communication channel from the call; and
resuming broadcasting the transmission for the call from the first communication unit on the outbound link of the first communication channel.

5. The method of claim 2 further comprising instructing communication units that are receiving the transmission for the call from the first communication unit on the first communication channel to tune to the second communication channel, and wherein broadcasting the transmission for the call from the second communication unit comprises broadcasting the transmission for the call from the second communication unit on the outbound link of the second communication channel.

6. The method of claim 1 wherein determining that the transmission for the call from the first communication unit should be interrupted by the transmission for the call from the second communication unit comprises determining that the second communication unit is of a higher priority than the first communication unit.

7. The method of claim 1 further comprising routing call information associated with the transmission for the call from the second communication unit to at least one dispatch console monitoring the call.

8. The method of claim 7 further comprising routing call information associated with the transmission for the call from the first communication unit to the at least one dispatch console monitoring the call.

9. The method of claim 1 wherein the step of broadcasting the transmission for the call from the second communication unit comprises merging the transmission for the call from the second communication unit with the transmission for the call from the first communication unit.

10. A method for managing competing call requests from a plurality of communication units participating in a call in a communication system, the method comprising:
receiving a first call request for the call from a first communication unit;
assigning a first communication channel at a first base site and a first communication channel at a second base site to the call;
receiving, at the first base site, a transmission for the call from a first communication unit on an inbound link of the first communication channel;
receiving a second call request from a second communication unit;
determining whether the transmission for the call from the first communication unit should be interrupted by a transmission for the call from the second communication unit;
identifying a communication channel to be utilized by the second communication unit;
receiving the transmission for the call from the second communication unit on an inbound link of the identified communication channel;
routing call information associated with the transmissions for the call from the first communication unit and the second communication unit to at least one dispatch console monitoring the call; and
if it is determined that the transmission for the call from the first communication unit should be interrupted by the transmission for the call from the second communication unit, broadcasting the transmission for the call from the second communication unit.

11. The method of claim 10 wherein the second communication unit is at the first base site and in communication with the first base site, and wherein the identified communication channel is a second communication channel that is assigned at the first base site.

12. The method of claim 11 further comprising instructing communication units that are receiving the transmission for the call from the first communication unit at the first base site to tune to the second communication channel; and
wherein broadcasting the transmission for the call from the second communication unit comprises broadcasting the transmission for the call from the second communication unit on an outbound link of the second communication channel at the first base site.

13. The method of claim 12 wherein broadcasting the transmission for the call from the second communication unit comprises broadcasting the transmission for the call on an outbound link of a first communication channel at a second base site.

14. The method of claim 10 wherein the second communication unit is at the second base site and in communication with the second base site, and wherein the identified communication channel is the first communication channel at the second base site.

15. The method of claim 10 wherein broadcasting the transmission for the call from the second communication unit comprises broadcasting the transmission for the call on an outbound link of the first communication channel at the first base site.

16. The method of claim 10 wherein broadcasting the transmission for the call from the second communication unit comprises broadcasting the transmission for the call on an outbound link of the first communication channel at the second base site.

17. The method of claim 10 wherein the step of broadcasting the transmission for the call from the second communication unit comprises merging the transmission for the call from the second communication unit with the transmission for the call from the first communication unit.

18. A method for managing call requests in a communication system, the method comprising:
receiving a first call request for a call from a first communication unit in a talkgroup;
assigning a first communication channel to the call;
receiving a transmission for the call from the first communication unit on an inbound link of the first communication channel;
receiving a second call request from a second communication unit in the talkgroup;
assigning a second communication channel to the call;
receiving a transmission from the second communication unit on an inbound link of the second communication channel; and
routing call information associated with both transmissions for the call from each of the first communication unit and the second communication units to at least one dispatch console monitoring the call.

19. The method of claim 18 wherein the call information comprises at least one of data, audio and video.

20. The method of claim 18 further comprises:
determining that the transmission for the call from the first communication unit should be interrupted by the transmission for the call from the second communication unit; and
broadcasting the transmission for the call from the second communication unit.

21. The method of claim 20 wherein broadcasting the transmission for the call from the second communication unit comprises broadcasting the transmission for the call from the second communication unit on the outbound link of the first communication channel.

22. The method of claim 20 wherein the step of broadcasting the transmission for the call from the second communication unit comprises merging the transmission for the call from the second communication unit with the transmission for the call from the first communication unit.

23. The method of claim 18 further comprising:
determining that the transmission for the call from the first communication unit should not be interrupted by the transmission for the call from the second communication unit; and
broadcasting the transmission for the call from the first communication unit.

24. The method of claim 18 wherein the first communication unit and the second communication unit are each in communication with a first base site, and wherein the second communication channel is assigned at the first base site.

25. The method of claim 18 wherein the first communication unit is in communication with a first base site and the second communication unit is in communication with a second base site, and wherein the second communication channel is assigned at the second base site.

26. The method of claim 18 further comprising:
receiving a call request from at least one additional communication unit in the talkgroup while the first and second communication units are transmitting;
assigning an additional communication channel for each additional communication unit that transmitted a call request;
receiving an additional transmission for the call from each additional communication unit on their respectively assigned communication channel; and
routing call information associated with each additional transmission for the call from each additional communication unit to the at least one dispatch console monitoring the call.
